(19) United States
(12) Patent Application Publication
(10) Pub. No.: US 2021/0204488 A1
(43) Pub. Date: Jul. 8, 2021

(54) SYSTEM AND METHOD OF VERTICAL FARMING FRAME MOUNT FIELD ARCHITECTURE FOR MULTIPLE CROP CLASSES

(71) Applicant: Samuel Westlind, Bozeman, MT (US)

(72) Inventor: Samuel Westlind, Bozeman, MT (US)

(21) Appl. No.: 17/143,352

(22) Filed: Jan. 7, 2021

Related U.S. Application Data
(60) Provisional application No. 62/958,009, filed on Jan. 7, 2020.
(60) Provisional application No. 62/970,947, filed on Feb. 6, 2020.
(60) Provisional application No. 63/085,781, filed on Sep. 30, 2020.

(51) Int. Cl. A01G 9/02; A01G 9/12; A01G 7/06

(52) U.S. Cl. CPC A01G 9/022; A01G 7/06; A01G 9/12

(57) ABSTRACT

A scalable precision distribution aeroponic system, including a modular frame mount constructed of a lightweight, rigid material, the frame mount including a pair of generally vertically oriented support members and at least one generally horizontally oriented crossmember positioned between the vertically oriented support members, the pair of generally vertically oriented support members operably coupled to the generally horizontally oriented crossmember via couplings, the couplings including a generally horizontally oriented support configured to extend substantially orthogonal to the horizontally oriented crossmember, and an interchangeable growth media operably coupled to the modular frame mount, the interchangeable growth media comprising a nourishment layer and a surface film, the nourishment layer defining one or more channels into which the generally horizontally oriented supports of the couplings are positioned for support of the interchangeable growth media.

### RELATED APPLICATIONS

The present application claims the benefit of U.S. Provisional Application No. 62/958,009 filed Jan. 7, 2020, U.S. Provisional Application No. 62/970,947 filed Feb. 6, 2020, and U.S. Provisional Application No. 63/085,781 filed Sep. 30, 2020, each of which is hereby incorporated herein in its entirety by reference.

### TECHNICAL FIELD

The present disclosure relates generally to aeroponic farm field apparatuses and methods of construction, and more particularly to modular field assemblies including a modular frame mount selectively coupled to an interchangeable growth media into which a nutrient rich water solution can be introduced, the modular field assemblies readily configurable to host a variety of crop classes at various stages throughout a growth cycle.

### BACKGROUND

Aeroponics is the process of growing plants in an air or mist environment without the use of soil or an aggregate medium. The basic principle of aeroponic growing is to grow plants suspended in a closed or semi-closed environment by spraying the plant roots and lower stem with an atomized nutrient rich water solution. The advantages of aeroponics are well documented; however, the use of aeroponics in a larger scale environment has proven a challenge.

Existing stack and tiered aeroponic systems are generally non-point distribution systems (e.g., systems in which the nutrient rich water solution is sprayed onto the plant roots by a large number of distribution nozzles), which lack both precision and even distribution of the nutrient rich water solution throughout the growth media. In particular, the plant roots positioned nearest to distribution nozzles receive an overabundance of solution, while the plant roots further away from the distribution nozzles do not receive enough solution. To compensate for these shortcomings and to reach all plant roots effectively, conventional aeroponic systems often require deep base units with multiple distribution nozzles mounted in each base unit. As a result, these systems typically require extensive, large diameter piping, and high pressure pumps with associated high operational costs. Further, replacement of the nozzles, which frequently wear out over time, is a labor-intensive process, which requires at least a partial dismantling of the base units to access the distribution nozzles.

Additionally, when using a pneumatic aeroponics spraying system with less than a 30 μm atomized spray, adhesion of the atomized nutrient rich water solution on the roots becomes difficult. Such an atomized solution is often considered to be a dry fog, as the solution particles tend to “bounce off” the plant roots and other surfaces. Where there is no surface for the atomized solution or moisture to adhere, the majority of the solution is wasted as it settles to the bottom of the base unit, eventually draining back to a sump, thus requiring a high frequency of cycles and/or longer cycle durations to maintain a desired nutrient delivery to the root zone environment. Further, with crops having larger plant root anchorage requirements, the atomized spray may not penetrate to the interior of the growth media, which can result in damage to the plant roots.

Scalable precision distribution aeroponic systems are desired. In particular, what is desired is an aeroponics system configured to enable increased quantity and frequency of crop production, as well as a grow environment to uniformly reach all available root grow surfaces within a root zone environment. Furthermore, what is desired is a system that can substantially reduce water usage, infrastructure and operational costs as nutrients are delivered and retained directly at the roots where and when needed. The present disclosure addresses these concerns.

### SUMMARY OF THE DISCLOSURE

The techniques of this disclosure generally relate to scalable precision distribution aeroponic systems and methods of construction configured to provide modular field assemblies including a modular frame mount selectively coupled to an interchangeable growth media into which a nutrient rich water solution can be introduced at a minimum number of distribution points (e.g., via a single distribution nozzle) while still maintaining a high degree of penetration of the atomized nutrient rich water solution into the root zone environment, the scalable precision aeroponic systems readily configurable to host a variety of crop classes at various stages throughout a growth cycle. Further, embodiments of the present disclosure enable various tooling (e.g., trellises, supports, lighting, moisture distribution and drainage mechanisms, airflow mechanisms, etc.) to be readily coupled to the aeroponic systems as desired. Moreover, embodiments of the present disclosure enable the more costly components of the scalable aeroponic systems to be recycled at the end of each crop lifecycle, thereby significantly reducing the cost associated with building and maintaining the aeroponic systems over multiple growing generations.

One embodiment of the present disclosure provides a modular frame mount for a precision distribution aeroponic system, including a pair of generally vertically oriented support members, at least one generally horizontally oriented crossmember positioned between the vertically oriented support members, and one or more couplings, wherein the pair of generally vertically oriented support members are operably coupled to the generally horizontally oriented crossmember via the one or more couplings, the couplings comprising a generally horizontally oriented support extending substantially orthogonal to the horizontally oriented crossmember and configured to support an interchangeable growth media selectively coupleable to the modular frame.

In one embodiment, the frame mount further comprises one or more bearing wheels configured to enable the modular frame mount to be hung in a generally vertical orientation in one embodiment, the couplings include at least one of a three-way T-shaped coupling, a three-way corner coupling, or a four-way coupling. In one embodiment, the pair of generally vertically oriented support members are constructed of an extruded aluminum tubing. In one embodiment, one or more components of the modular frame mount are operably coupled together via a pin coupling. In one embodiment, at least one of a trellis or other plant supporting structure is selectively coupleable to the generally horizontally oriented supports of the modular frame mount.

Another embodiment of the present disclosure provides a scalable precision distribution aeroponic system, including a modular frame mount constructed of a lightweight, rigid material, and an interchangeable growth media operably coupled to the modular frame mount, the interchangeable growth media comprising a nourishment layer having a first thickness, and a surface film having a second thickness, the nourishment layer defining one or more channels into which a portion of the modular frame, thereby coupling the interchangeable growth media to the modular frame mount.

In one embodiment, the nourishment layer of the interchangeable growth media is constructed of a reticulated foam material. In one embodiment, the reticulated foam material includes a plurality of a pores with a spacing of between about 5 and about 15 pores per square inch. In one embodiment, the surface film of the interchangeable growth media is constructed of a biaxially-oriented polyethylene terephthalate material. In one embodiment, the surface film is constructed of at least one of a corona treated mylar or reflective polyester film. In one embodiment, the nourishment layer and the surface film are operably coupled to one another via an adhesive. In one embodiment, the adhesive has a melting point configured to enable separation of the nourishment layer from the surface film for recycling of at least one of the nourishment layer or surface film upon completion of a growth cycle.

Another embodiment of the present disclosure provides a scalable precision distribution aeroponic system, including a modular frame mount constructed of a lightweight, rigid material, the frame mount comprising a pair of generally vertically oriented support members and at least one generally horizontally oriented crossmember positioned between the vertically oriented support members the pair of generally vertically oriented support members operably coupled to the generally horizontally oriented crossmember via couplings, the couplings including a generally horizontally oriented support configured to extend substantially orthogonal to the horizontally oriented crossmember, and an interchangeable growth media operably coupled to the modular frame mount, the interchangeable growth media comprising a nourishment layer and a surface film, the nourishment layer defining one or more channels into which the generally horizontally oriented supports of the couplings are positioned for support of the interchangeable growth media.

In one embodiment, the interchangeable growth media defines one or more channels configured to enable efficient distribution of an atomized nutrient rich water solution. In one embodiment, the one or more channels have a width of between about 1 inch and about 6 inches and a depth between about ¼ of an inch and about 3 inches. In one embodiment, the one or more channels can define one or more atomized nutrient rich water solution congregation points. In one embodiment, the interchangeable growth media includes one or more plant apertures co-positioned at the one or more atomized nutrient rich water solution congregation points.

In one embodiment, the scalable precision distribution aeroponic system further includes a distribution nozzle positioned within the one or more channels, the distribution nozzle configured to introduce an atomized nutrient rich water solution into the one or more channels for distribution throughout at least a portion of the interchangeable growth media. In one embodiment, the scalable precision distribution aeroponic system further includes at least one of a blower or vacuum mechanism configured to promote a flow of gas through the one or more channels, wherein the flow of gas is configured to at least one of promote an increase in distribution of the atomized nutrient rich water solution, aid in heat dissipation, enable temperature and/or humidity control of the root zone environment, or a combination thereof.

Yet another embodiment of the present disclosure provides a precision vertical aeroponics distribution system having an increased surface area configured to form a defined, controlled delivery mechanism for uniform atomized nutrient distribution throughout a vertical field. Horizontal ledges within the root zone environment on the back of fields can be utilized to retain the atomized nutrients. Accordingly, a single pneumatic nozzle mounted near the bottom of the root zone environment can dispense upwardly to fill the root zone environment with a moisture and nutrient rich “fog.” As the fog dispenses, it will begin to adhere on any available surface. With increased surface area, such as horizontal channels approximately 4″ high and 0.75″ deep, the fog tends to adhere to the upper channel surface on the way up and settles on the lower channel surface on the way back to sump. Positioning these channels around the plant sites enables moisture to be effectively captured and retained by the 10 PPI reticulated foam for plant use between fog cycles. In this manner the fog is dispersed via low cost pneumatics, without a high-pressure system or bulky infrastructure including multiple nozzles required of conventional aeroponic systems. Accordingly, embodiments of the present disclosure enable the effective distribution of a moisture and nutrient rich fog with a single nozzle at a low frequency, and with a minimal duration cycle.

In one embodiment, bore holes of different diameters can be distributed throughout a vertical field foam, and an aeroponics nozzle can drive fog through the bore along the entire length of a vertical field planted row. In one embodiment, the precision distribution system of increased surface area bore holes can service one or more large canopy plant sites. In one embodiment, the exposed interior vertical field surface within the root zone environment can have contoured features to increase surface area to capture fog for individual root sites. In one embodiment, an exposed channel can form a fog collection point. In one embodiment, the precision distribution system of increased surface area can have one or more routes of bore holes and contours. In one embodiment, the precision distribution system of increased surface area bore holes act as tubes. In one embodiment, the precision distribution system of increased surface area bore holes and channels can be interconnected to allow circulation. In one embodiment, the precision distributed system of increased surface area can be configured for individual field architecture by crop class. In one embodiment, the precision distribution system of increased surface area can be configured for different crop classes. In one embodiment, a tongue and groove mechanism on the side of the fields can be configured to selectively lock the fields together and inhibit fog from dispersing into the canopy grow space.

Embodiments of the present disclosure are configured to precisely distribute fluids within a controlled root zone environment. In particular, embodiments of the present disclosure are configured to deliver and collect aeroponic spray at individual root sites or along entire crop rows. The precision distributed system of increased surface area can have one or more routes configured for the one or more plant sites. The bore holes within the vertical field can be used individually on a per plant basis. In some embodiments, the contours on the exposed interior surface of a vertical field require only a single aeroponics distribution nozzle per unit to service the root zone environment of one farm unit. The precision distributed system of increased surface areas can be used together or separately, The bore holes can act as fluid lines within the root zone environment. Within a controlled root zone environment, precision nutrient delivery, uniform air delivery, precise individual plant site delivery of gases, temperature, humidity or dehumidification, nutrients and other plant needs can be delivered instantaneously. In some embodiments, the fog captured by the contours and bore holes at each root site is retained within the reticulated foam, thus allowing the efficiency gains of minimal frequency and duration of on cycles and offers system redundancy as moisture is available to roots in the event of a pump failure.

Accordingly, embodiments of the present disclosure eliminate the need of consumables such as rock wool cubes etc., thus saving time, money and minimizing waste streams. In sonic embodiments, the systems and methods disclosed herein can be configured to advance through the high-volume continuous production line throughout the plant growth cycle, In some embodiments, such a field system offers the control necessary across all crop roots within the root zone environment with nutritional and proper environmental control for an by the minute optimized grow season at a granular, per plant root basis thus offering superior crop health, higher yields and a faster cycle time to harvest. Such systems further enable gains in efficiency for scaling hydroponic indoor commercial farm production, thereby enabling existing and new crops to be profitably grown indoors.

In some embodiments, compressed gases or a fan can induce proper fluid movement throughout the root zone environment. Air conditioning, humidity and other gases can be remotely added to the airflow for an optimized growth. Such precision air movement enables a granular per plant site root zone management of the grow environment. Such granular fluid control greatly reduces any excessively dry or wet spots within the grow environment thus reducing disease or fungus potential and greatly reducing pest harborage. Embodiments of the present disclosure offer more complete control of the root zone environment, as well as enabling additional tooling to be installed within the root zone environment as well as in proximity to the plant canopy. Such a precision fluid movement systems incorporated within the root zone environment enable system irrigation, gas recipes and environmental control to a to be highly controlled within the root zone environment. In some embodiments, the air source can be filtered to clean room standards, filtered outside air and or recirculated depending on farm needs. Fluid waste can be vented directly out to the indoor farm facility environment, recaptured or piped to exhaust outside. The aeroponics spray sump can be drain to waste or recirculated. The fluid retention within the vertical field greatly reduces frequency and duration of cycles. Such a system delivers fluids as needed, when needed. Increasing system efficiency and utilizing volumetric space efficiently within the root zone environment while providing granular per plant site environmental control reduces the grow environment to the efficiencies of assembly line processes.

Accordingly, embodiments of the present disclosure, alternatively referred to as “AutoCrop LLC ultralight modular vertical farms,” components of which can be referred to as the EZ Rail™ and RZE™, reduce plant production to the efficiencies of assembly line processes. Embodiments of the present disclosure can offer one binary input output low cost, common irrigation and drain that is an unobstructed root zone environment throughout the length and height of system run allowing a single, bottom mounted aeroponics nozzle. This binary vertical farm design allows a vertical field with precision distributed system of increased surface area aeroponics system to vertically scale efficiently while maintaining affordable proper root zone environment control along the entire length of run. Such as system used together offers a user the complete aeroponic control with complete environmental control of the local root zone environment. The precision distributed system of increased surface area aeroponics can use one or more pneumatic MicroFog Atomizers by AeroScience Inc. The independent bore holes and contours allow the plant roots to be sufficiently exposed to fog at all growth points. The remote air delivery is via an air compressor. A pneumatically powered atomizer can throw air and particulate great distances. Compressed gases can power the atomizer. The air pressure allows the pressuring of the root zone environment. The pressurized fog disperses directly onto the roots and deep within the field pores. This additional moisture within the field core reduces runoff, gives roots moisture between cycles, and reduces frequency of cycles. The combination of the precision distributed system of increased surface area within the root zone environment result in a new hybrid system with the advantages of traditional aeroponics and the AutoCrop™ vertical field architecture. Such as system is ultralight, modular and has little system waste. With a minimal wastewater stream, the hybrid system can allow a drain to waste sump. This minimizes infrastructure throughout the growth cycle, thus reducing agriculture production to the efficiencies of assembly line processes. As the vertical field advances through the system from seed to harvest different recipes and cycles, nutrients, and conditioned gas mixes are utilized to optimize plant growth within the grow enclosure. The environmental control uses different air speeds, air temperatures, gas composition and humidity to replicate an ideal grow season for the crop grown. Such a continuous production and precision aeroponics system can also be utilized with traditional horizontal plane growing methods and use traditional aeroponic components.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a perspective view depicting a frame mount, in accordance with an embodiment of the disclosure.

FIG. 2A is a plan view depicting the frame mount of FIG. 1.

FIG. 2B is a profile view depicting the frame mount of FIG. 2A.

FIG. 2C is a detailed view of a portion of the frame mount of FIG. 2B.

FIG. 3 is a perspective view of a frame mounted pin coupling, in accordance with an embodiment of the disclosure.

FIG. 4 is a perspective view depicting an aeroponic system, in accordance with an embodiment of the disclosure.

FIG. 5A is a back plan view depicting the aeroponic system of FIG. 4.

FIG. 5B is a profile view depicting the aeroponic system of FIG. 5A.

FIG. 5C is a detailed view of a portion of the aeroponic system of FIG. 5B.

FIG. 6A is a front plan view depicting the depicting the aeroponic system of FIG. 4.

FIG. 6B is a detailed view of a portion of the vertical field assembly of FIG. 6A.

FIG. 7A is a rear profile view depicting an aeroponic system, in accordance with an embodiment of the disclosure.

FIG. 7B is a side view depicting the aeroponic system of FIG. 7A.

FIG. 7C is a front profile view depicting t the aeroponic system of FIG. 7A.

FIG. 8 is a perspective view depicting an aeroponic system, in accordance with an embodiment of the disclosure.

FIG. 9 is a perspective view depicting a plant supporting structure, in accordance with an embodiment of the disclosure.

FIG. 10 is a perspective view depicting an aeroponic enclosure, in accordance with an embodiment of the disclosure.

FIG. 11 is a perspective view depicting an aeroponic enclosure, in accordance with another embodiment of the disclosure.

FIG. 12 is a flow diagram depicting a series of aeroponic enclosures positioned along a projected growth cycle, in accordance with another embodiment of the disclosure.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

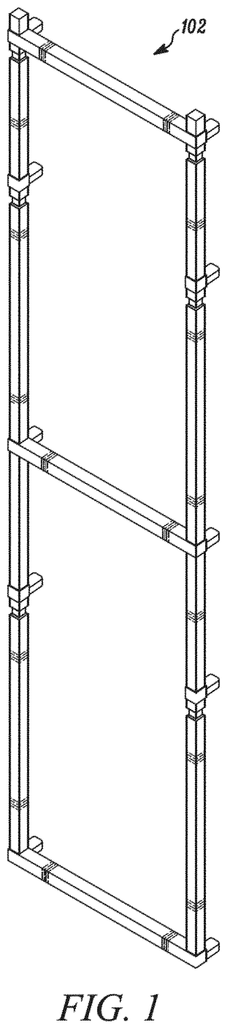

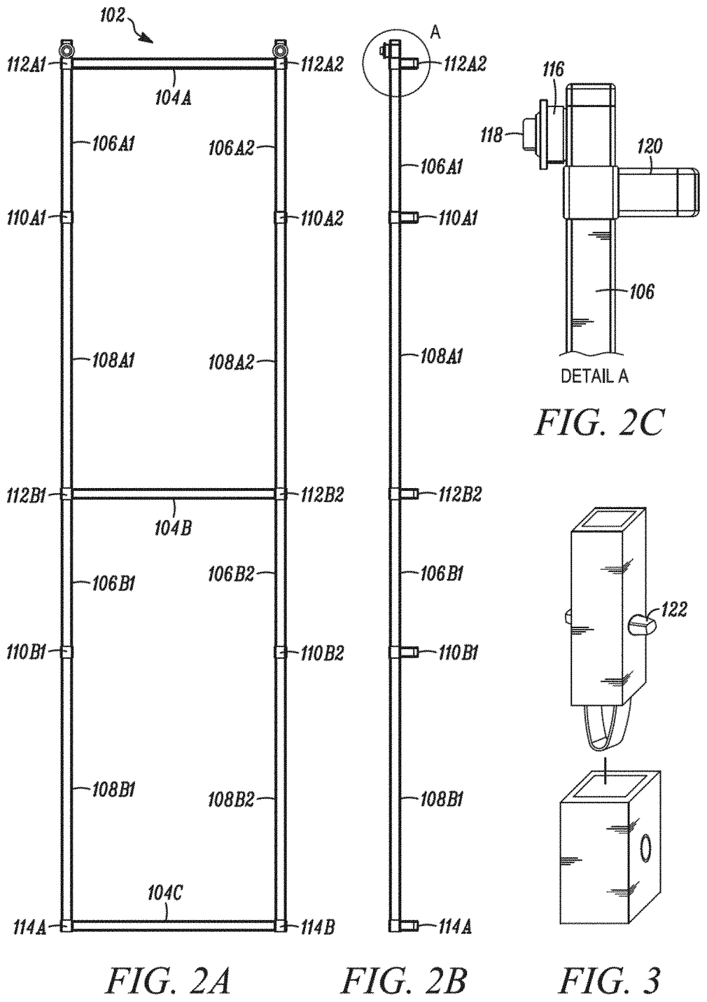

Referring to FIGS. 1 and 2A-C, a modular frame mount 102 (alternatively referred herein to as a “universal frame mount” or “field frame assembly”), is depicted in accordance with an embodiment of the disclosure. In some embodiments, the frame mount 102 can be constructed of a high strength, lightweight, rigid material. For example, in one embodiment, the frame mount 102 can be constructed of extruded aluminum tubing, wherein one or more components of the frame mount 102 are operably coupled together via one or more couplings are connectors, thereby enabling rapid assembly and disassembly of the frame mount 102.

As depicted in FIGS. 2A-B, in one embodiment, the frame mount 102 can include first rigid members 104A, 104B and 104C, second rigid members 106A1, 106A2, 106B1, and 106B2, and third rigid members 108A1, 108A2, 108B1, and 108B2. In some embodiments, the first, second and third rigid members 104, 106 and 108 can be of different respective lengths. For example, in one embodiment, the first rigid members 104 can have a length of about 20 inches, the second rigid members 106 can have a length of about 14 inches, and the third rigid members 108 can have a length of about 26 inches; although other lengths are also contemplated. In some embodiments, the second rigid members 106 and third rigid members 108 can be configured as generally vertically oriented support members, with respect to a gravitational frame of reference, while the first rigid members 104 can be configured as generally horizontally oriented support members with respect to the gravitational frame of reference, wherein the at least one first rigid member 104 is positioned between corresponding pairs of the second or third rigid members 106, 108. In some embodiments, the first rigid members 104 can be positioned substantially orthogonal to the second and third rigid members 106, 108 within a given plane; although other angles and configurations are also contemplated.

The various first, second and third rigid members 104, 106 and 108 can be operably coupled to one another via first connectors 110A1, 110A2, 110B1, and 110B2, second connectors 112A1, 112A2, 112B1, and 112B2, and third connectors 114A and 114B. In one embodiment, the first connectors 110 can be configured as a three-way, T-shaped coupling, the second connectors 112 can be configured as a four-way coupling, and the third connectors 114 can be configured as a three-way corner coupling; although other types of couplings are also contemplated. In embodiments, the couplings 110, 112, 114 can each include a support 120 (as depicted in FIG. 2C) configured to be generally horizontally oriented with respect to a gravitational frame of reference, to extend away from the plane of the first second and third rigid members 104, 106, 108. For example, in one embodiment, each of the supports 120 can be positioned substantially orthogonal to the horizontally oriented first rigid members; although other angles and configurations are also contemplated.

As depicted in FIG. 2C, in one embodiment, one or more bearing wheels 116 can be operably coupled to the connectors 112A1, 112A2, for example via shoulder screw 118, thereby enabling the frame mount 102 to be operably coupled to an overhead railing or other transport mechanism. In other embodiments, frame mount 102 can include one or more brackets (not depicted) configured to enable the frame mount 102 to be hung in a generally vertical orientation with respect to a gravitational frame of reference, such as that disclosed in Patent Cooperation Treaty App Ser. No. PCT/US2018/062035 (filed Nov. 20, 2018), the contents of which are incorporated by reference herein.

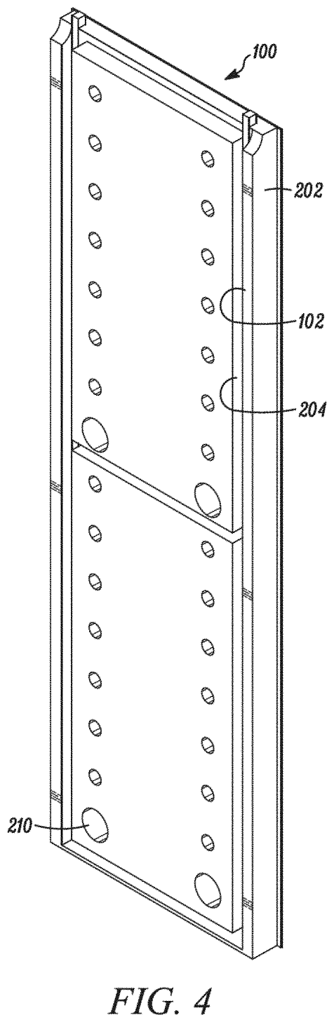

In some embodiments, the various connectors 110, 112, 114 can be configured to enable rapid assembly and disassembly of the frame mount 102. For example, in one embodiment, the various connectors 110, 112, 114 can include quick connect/disconnect buttons or other type of pin coupling 122 (as depicted in FIG. 3), thereby enabling the various components of the frame mount 102 to selectively and rapidly lock into place relative to one another, thereby contributing to the overall modularity of the frame mount 102 design. In some embodiments, one or more edges of the frame mount 102, supports 120 and/or pin couplings 122 can be rounded to inhibit wear and tear on softer materials that may be coupled to the modular frame mount 102, thus preserving the integrity of the soft materials.

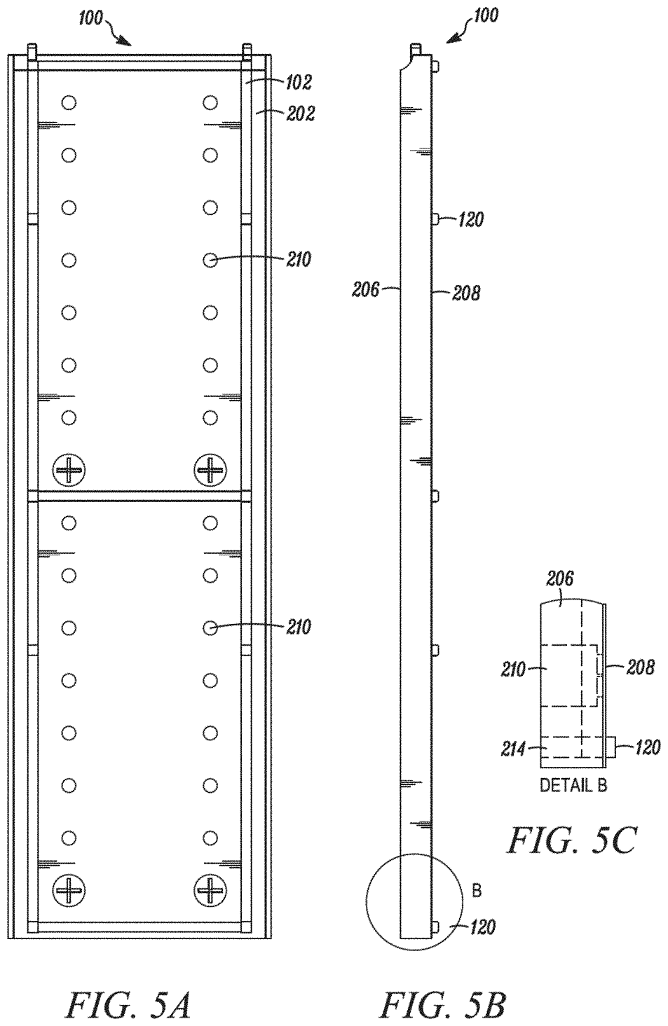

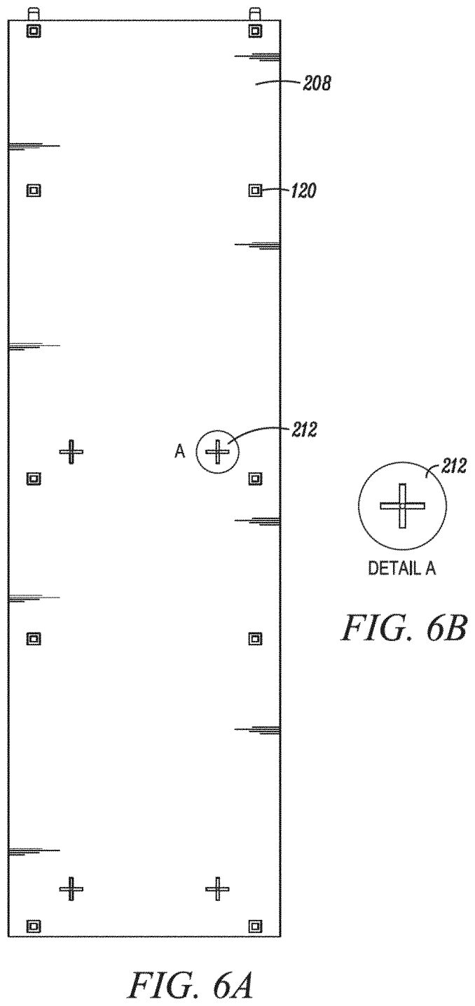

Referring to FIGS. 4, 5A-C and 6A-B a scalable precision distribution aeroponic system 100 is depicted in accordance with an embodiment of the disclosure. In some embodiments, the aeroponic system 100 can include a modular frame mount 102 (such as that depicted in FIGS. 1 & 2A-C) and an interchangeable growth media 202. For example, in some embodiments, the growth media 202 can be selectively coupled to the frame mount 102 via the generally horizontally oriented supports 120. In particular, in some embodiments, the growth media 202 can define one or more channels 204 into which at least a portion of the frame mount 102 can be positioned, thereby operably coupling the growth media 202 to the frame mount 102.

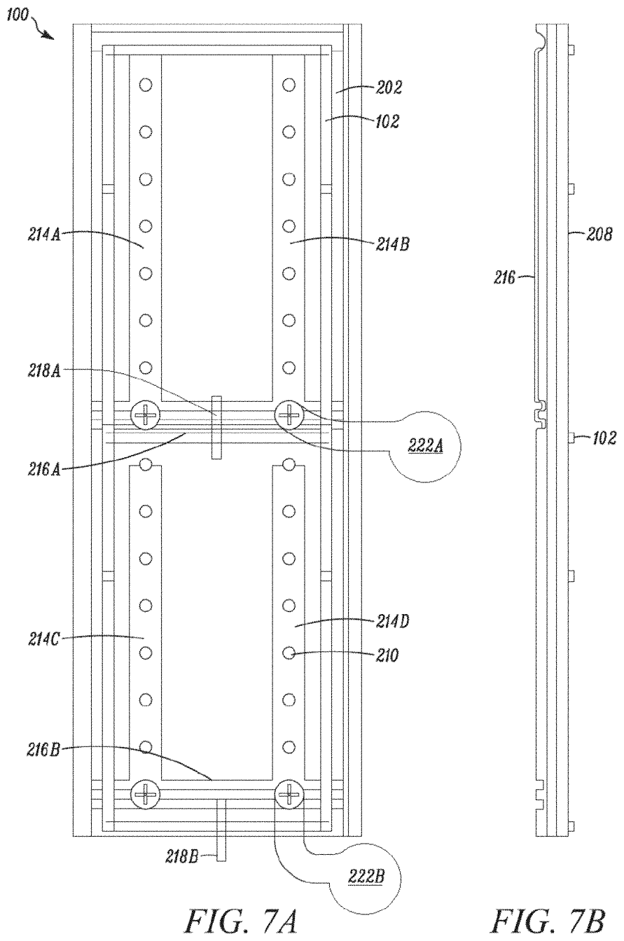

In some embodiments, a portion of the frame mount 102 (e.g., ends of the respective supports 120) can penetrate entirely through the growth media 202 (as depicted in FIG. 6A), thereby enabling various types of tooling (e.g., trellises, supports, lighting, moisture distribution and drainage mechanisms, airflow mechanisms, etc.) to be readily coupled to the aeroponic system 100 as desired. Other methods of coupling the growth media 202 to the frame mount 102 are also contemplated. For example, in some embodiments, additional clips and/or reusable adhesives can be used to operably couple the growth media 202 to the frame mount 102. In other embodiments, the frame mount 102 can be used to sandwich the growth media 202 between the aluminum frame and a rigid exterior surface.

In some embodiments, the growth media 202 can be a multilayer assembly, which in some embodiments can include one or more nourishment layers 206 having a first thickness, and at least one surface layer 208 having a second thickness (as depicted in FIG. 5C). In some embodiments, first thickness of the one or more nourishment layers 206 can be larger than the second thickness of the at least one surface layer 208.

In some embodiments, the nourishment layer 206 can be constructed of a reticulated foam material. In some embodiments, the reticulated foam material can define a plurality of pores having a poor spacing of between about 5 pores and about 15 pores per square inch (PPI); with a nominal PPI of about 10 pores per square inch; although the use of other materials with other pore spacing is also contemplated.

In some embodiments, the at least one surface layer 208 can be a thin-film adhered to an outer surface of the nourishment layer 206. In some embodiments, the at least one surface layer 208 can be constructed of a biaxially-oriented polyethylene terephthalate (BoPet) material. For example, in one embodiment, the surface layer or film 208 can be a corona treated mylar, or other highly reflective, polyester film made from stretched polyethylene terephthalate. In some embodiments, the at least one surface layer 208 can be adhered to the nourishment layer 206 via an adhesive. For example, in one embodiment, the adhesive can be hot glue or other type of adhesive having a melting point configured to enable separation of the surface layer 208 from the nourishment layer, for recycling of at least one of the nourishment layer 206 or surface layer 208 upon completion of the growth cycle. At the end of the service life of a growth media 202, the growth media 202 can be rapidly disassembled. For example, in one embodiment, the hot glue can be reheated to enable disassembly of the various components, and the expensive components can be recycled in a later growth media 202, thereby minimizing waste.

In some embodiments, the nourishment layer 206 can define one or more channels or apertures 210 or other congregation points where a nutrient rich water solution introduced into the growth media 202 can generally congregate. In some embodiments, the nourishment layer 206 can define one or more plant apertures 212 (e.g., in the form of a cross slit) into which seeds, a seedling or other plant can be positioned for growth. In embodiments, the one or more plant apertures 212 can be co-positioned at the one or more apertures 210 or other points where nutrient rich water solution tends to congregate.

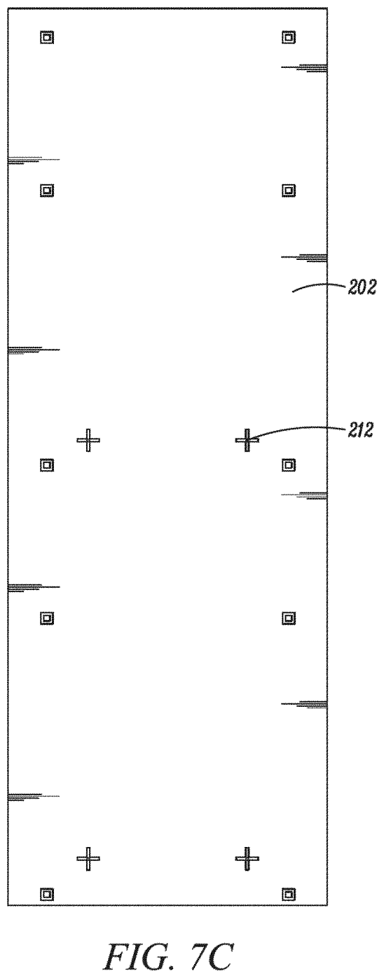

Referring to FIGS. 7A-C, another embodiment of a precision distribution aeroponic system 100, is depicted in accordance with an embodiment of the disclosure. Various embodiments are described in detail with reference to the drawings, wherein like reference numerals represent like parts and assemblies throughout the several views. In some embodiments, the one or more apertures 210 or other points where a nutrient rich water solution tends to congregate can be positioned within one or more channels through which and atomized spray of a nutrient rich water solution can be distributed.

For example, in some embodiments, the growth media 202 can define one or more vertical channels 214A-D and/or one or more horizontal channels 216A-B configured to enable an efficient distribution of atomized nutrients and moisture (occasionally referred to herein as a “fog”). In some embodiments, the one or more channels 214, 216 can have a width of between about 1 inch and about 6 inches, and a depth of between about ¼ of an inch and about 3 inches.

For example, in one embodiment, the vertical channels 214A-D can have a width of about 3 inches and a depth of about 0.75 inches, and the horizontal channels 216A-B can have a width of about 1 inch and a depth of about 0.75 inches. Other dimensions of the channels are also contemplated.

In some embodiments, the one or more apertures 210 or other points for nutrients rich water solution tends to congregate can be located within the channels 214, 216. Additionally, one or more plant apertures 212 into which seeds, a seedling or other plant can be positioned for growth, can be co-located with the one or more apertures 210, thereby creating an optimal root zone environment for plant roots in proximity to the one or more plant apertures 212. In embodiments, individual plants can be positioned within each of the plant apertures 212, such that roots of plants positioned within the plant apertures to into naturally extend into the channels 114, 116 for increased exposure to the nutrient rich fog.

In some embodiments, the aeroponic system 100 can include a distribution nozzle 218A/B positioned within at least one of the channels 214/216, wherein the distribution nozzle 218 AB is configured to introduce an atomized nutrient rich water solution into the one or more channels 214/216 for distribution throughout at least a portion of the growth media 202. Further, in some embodiments, the aeroponic system 100 can include other ductwork and/or fan such as a blower or vacuum mechanism 222 configured to promote a flow of gas through the one or more channels 214, 216, wherein the flow of gas configured to at least one of promote an increase in distribution of the atomized nutrient rich water solution, aid in heat dissipation (e.g., dissipate heat generated by the grow lights absorbed by the growth media 202) enable precise control of temperature and/or humidity within the root zone environment, or a combination thereof.

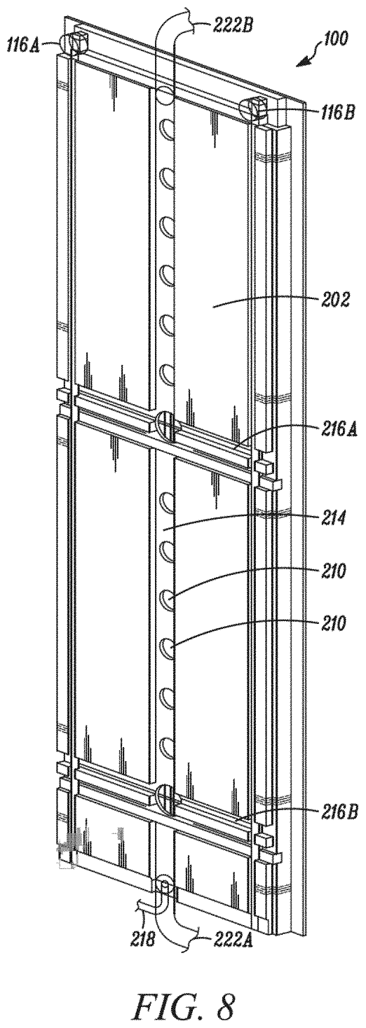

Referring to FIG. 8, a precision distribution aeroponic system 100 is depicted in accordance with another embodiment of the disclosure. In some embodiments, the aeroponic system 100 can include a single vertical channel 214 in which a plurality of apertures 210 or other points where a nutrient rich water solution tends to congregate can be defined. In some embodiments, the aeroponic system 100 can include a single distribution nozzle 218 configured to introduce an atomized nutrient rich water solution into the one or more channels 214/216 for distribution throughout at least a portion of the growth media 202. One or more bearing wheels 116A/B can be coupled to the aeroponic system 100, thereby enabling the aeroponic system 100 to be suspended and move along an overhanging track. For additional details regarding the aeroponic system 100 design, see U.S. Design Patent Application Ser. No. 29/753,449 (filed Sep. 30, 2020), the contents of which are hereby incorporated by reference herein.

Ductwork and/or one or more blower or vacuum mechanism 222A/B configured to promote a flow of gas through the one or more channels 214, 216A/B. For example, in one embodiment, a blower 222A can be positioned on one end of the aeroponic system 100 and vacuum source can be positioned on another end of the aeroponic system 100; although other configurations of ductwork and/or one or more blower or vacuum mechanisms 222 is also contemplated. Accordingly nutrient rich fog introduced by the distribution nozzle 218 can be guided by air currents within the horizontal and vertical channels 214, 216A/B, which can be controlled to optimize circulation of the atomized nutrients and moisture within the root zone environment, thereby minimizing the need to recycle nutrient fluids, particularly in comparison to aeroponic systems of the prior art. Circulation of fluids within the horizontal and vertical channels can further aid in heat dissipation and removal (e.g., from the light source), and improved control of temperature and humidity within the root zone environment.

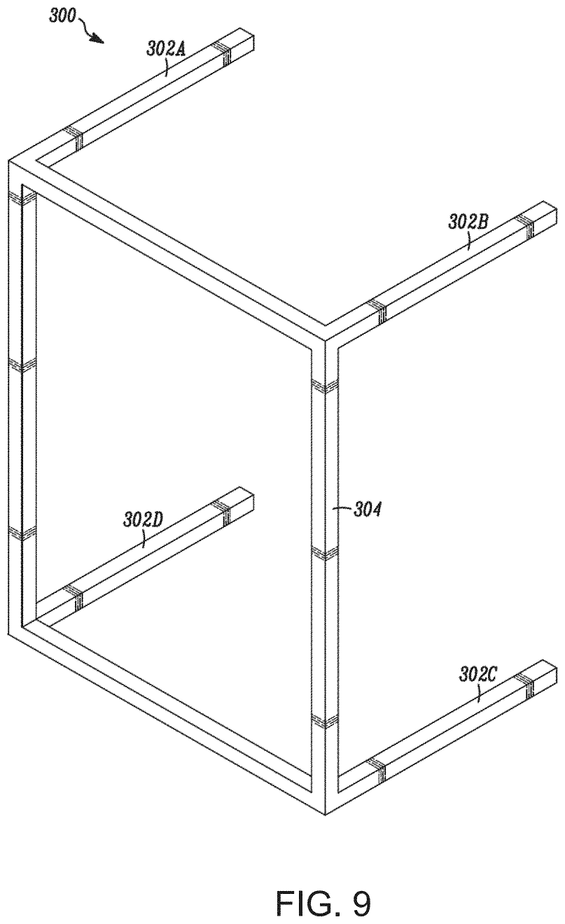

In some embodiments, additional tooling such as additional roller assemblies, and additional structures (e.g., trellises, screens, netting, supports, lighting, moisture distribution and drainage mechanisms, airflow mechanisms, etc.) can be operably coupled to the ends of the supports 120, which in some embodiments penetrate entirely through the growth media 202 (as depicted in FIG. 5B, 6A & 7A). One example of a plant supporting structure 300 is depicted in FIG. 9. In one embodiment, the plant supporting structure 300 can include a plurality of legs 302A-D selectively coupleable to the supports 120. The plurality of legs 302A-D can support a frame structure 304 or other structure configured to support a plant canopy. Although a relatively simple trellis is depicted in FIG. 9, other, potentially more complicated plant supporting systems operably coupleable to supports 120 are also contemplated. For additional details regarding the plant supporting structures 300, see Patent Cooperation Treaty App Ser. No. PCT/US2020/032337 (filed May 11, 2020), the contents of which are hereby incorporated by reference herein.

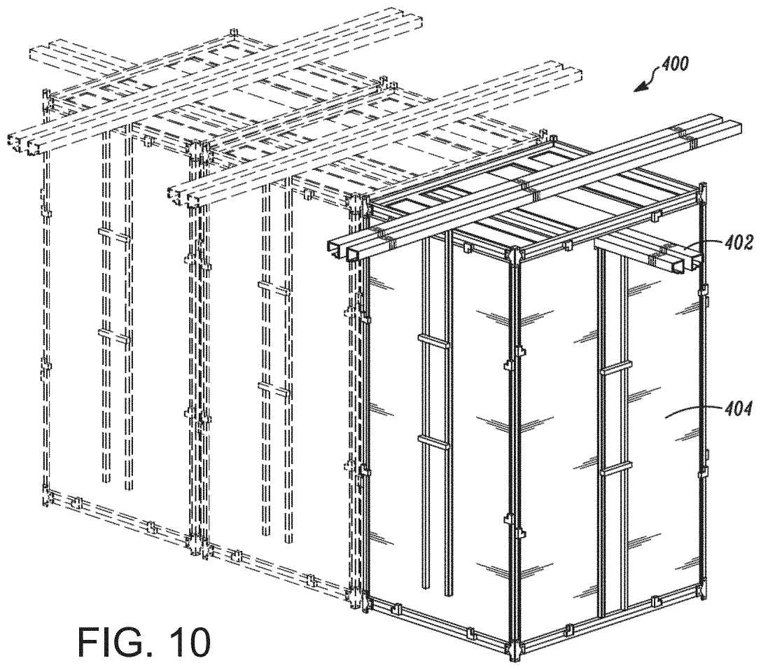

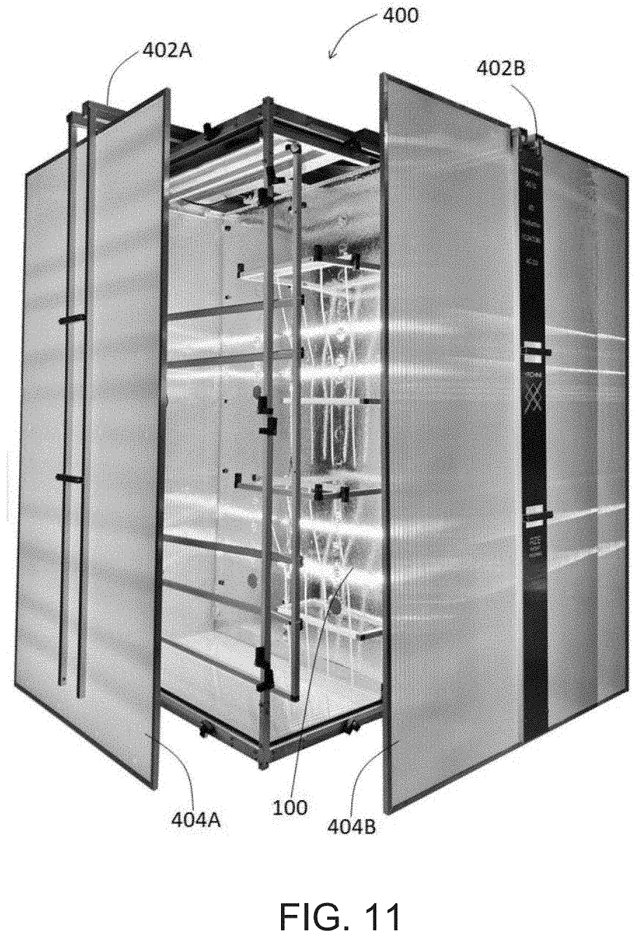

With reference to FIGS. 10-11, an aeroponic enclosure 400 configured to at least partially house one or more aeroponic systems 100 is depicted in accordance with an embodiment of the disclosure. In some embodiments, the aeroponic enclosure 400 can include one or more rails 402A/402B upon which bearing wheels 116 of the one or more aeroponic systems 100 can be positioned, thereby enabling the one or more aeroponic systems 100 to be suspended within the aeroponic enclosure 400, while enabling ease in lateral movement of the aeroponic systems 100 from one position to another (e.g., during different growth cycles). In some embodiments, the aeroponic enclosure 400 can include one or more sides 404A/B, which can be configured with a variety of lights and/or ductwork to provide optimal growth conditions to plants contained within the aeroponic enclosure 400. In some embodiments the one or more sides 404A/B can be configured to slide along the one or more rails 402A/402B between an open and a closed position. For additional details regarding the aeroponic enclosure 400 design, see U.S. Design Patent Application Ser. No. 29/739,358 (filed Jun. 24, 2020), the contents of which are hereby incorporated by reference herein.

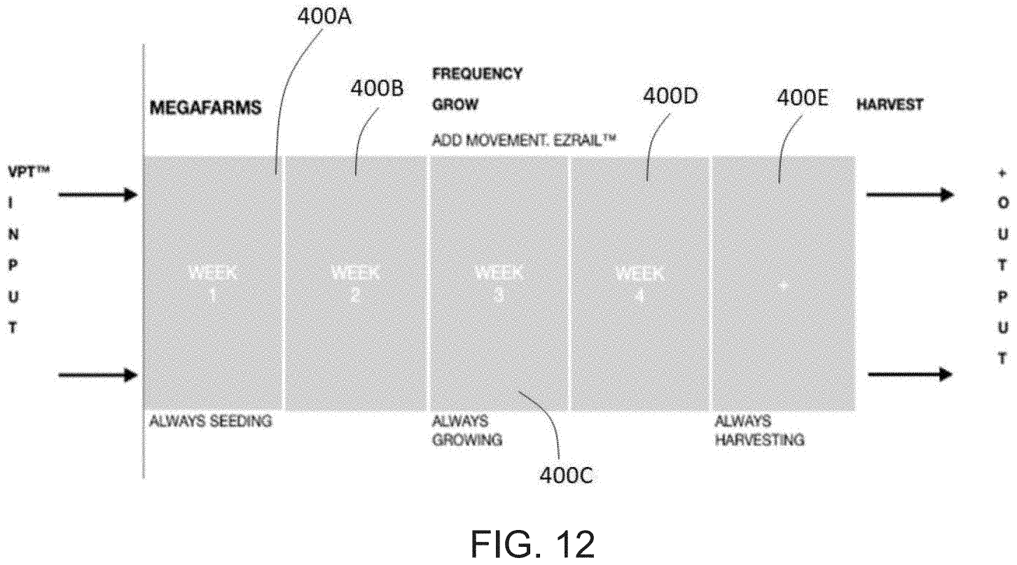

With additional reference to FIG. 12, in some embodiments, a plurality of aeroponic enclosures 400A-E can be positioned in series to create optimum growth conditions for a plant as it matures from a seed or seedling to a mature/ready to be harvested plant. For example, in some embodiments, individual aeroponic systems 100 positioned within the aeroponic enclosures 400 can move from one end of the plurality of aeroponic enclosures (e.g., enclosure 400A) to the other end of the plurality of aeroponic enclosures (enclosures 400E); although other combinations and configurations of pluralities of aeroponic enclosures are also contemplated.

Although the disclosure primarily discusses use of the systems 100 in terms of aeroponic growth systems, the systems and methods disclosed herein may equally be applicable to hydroponic growth systems. Accordingly, such a manufactured enclosure 400 architecture (including one or more vertical field architecture system 100) streamlines manufacturing, reduces the processes of seeding, growing and harvesting to the efficiencies of assembly processes thus establishing the efficiency gains necessary for scaling aero- and hydroponic indoor commercial agriculture.

Accordingly, embodiments of the present disclosure provide a simple and robust vertical field architecture that is efficient to manufacture with a standardized system architecture across multiple crop classes and farm types. Moreover, the systems and methods as disclosed herein are configured to enable an assembly line approach to efficient vertical field manufacturing across multiple crop classes. In situ, mechanized and automated seeding of seeds, seedlings and clones directly into manufactured vertical field apertures can be completed in a rapid manner.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A modular frame mount for a precision distribution aeroponic system, comprising:
a pair of generally vertically oriented support members;
at least one generally horizontally oriented crossmember positioned between the vertically oriented support members; and
one or more couplings, wherein the pair of generally vertically oriented support members are operably coupled to the generally horizontally oriented crossmember via the one or more couplings, the couplings comprising a generally horizontally oriented support extending substantially orthogonal to the horizontally oriented crossmember and configured to support an interchangeable growth media selectively coupleable to the modular frame.

2. The modular frame mount of claim 1, wherein the frame mount further comprises one or more bearing wheels configured to enable the modular frame mount to be hung in a generally vertical orientation

3. The modular frame mount of claim 1, wherein the couplings include at least one of a three-way T-shaped coupling, a three-way corner coupling, or a four-way coupling.

4. The modular frame mount of claim 1, wherein the pair of generally vertically oriented support members are constructed of an extruded aluminum tubing.

5. The modular frame mount of claim 1, wherein one or more components of the modular frame mount are operably coupled together via a pin coupling.

6. The modular frame mount of claim 1, wherein at least one of a trellis or other plant supporting structure is selectively coupleable to the generally horizontally oriented supports of the modular frame mount.

7. A scalable precision distribution aeroponic system, comprising:
a modular frame mount constructed of a lightweight, rigid material; and
an interchangeable growth media operably coupled to the modular frame mount, the interchangeable growth media comprising a nourishment layer having a first thickness, and a surface film having a second thickness, the nourishment layer defining one or more channels into which a portion of the modular frame, thereby coupling the interchangeable growth media to the modular frame mount.

8. The scalable precision distribution aeroponic system of claim 7, wherein the nourishment layer of the interchangeable growth media is constructed of a reticulated foam material.

9. The scalable precision distribution aeroponic system of claim 8, wherein the reticulated foam material includes a plurality of a pores with a spacing of between about 5 and about 15 pores per square inch.

10. The scalable precision distribution aeroponic system of claim 7, wherein the surface film of the interchangeable growth media is constructed of a biaxially-oriented polyethylene terephthalate material.

11. The scalable precision distribution aeroponic system of claim 10, wherein the surface film is constructed of at least one of a corona treated mylar or reflective polyester film.

12. The scalable precision distribution aeroponic system of claim 7, wherein the nourishment layer and the surface film are operably coupled to one another via an adhesive.

13. The scalable precision distribution aeroponic system of claim 12, wherein the adhesive has a melting point configured to enable separation of the nourishment layer from the surface film for recycling of at least one of the nourishment layer or surface film upon completion of a growth cycle.

14. A scalable precision distribution aeroponic system, comprising:
a modular frame mount constructed of a lightweight, rigid material, the frame mount comprising a pair of generally vertically oriented support members and at least one generally horizontally oriented crossmember positioned between the vertically oriented support members, the pair of generally vertically oriented support members operably coupled to the generally horizontally oriented crossmember via couplings, the couplings including a generally horizontally oriented support configured to extend substantially orthogonal to the horizontally oriented crossmember; and
an interchangeable growth media operably coupled to the modular frame mount, the interchangeable growth media comprising a nourishment layer and a surface film, the nourishment layer defining one or more channels into which the generally horizontally oriented supports of the couplings are positioned for support of the interchangeable growth media.

15. The scalable precision distribution aeroponic system of claim 14, wherein the interchangeable growth media defines one or more channels configured to enable efficient distribution of an atomized nutrient rich water solution.

16. The scalable precision distribution aeroponic system of claim 15, wherein the one or more channels have a width of between about 1 inch and about 6 inches and a depth between about ¼ of an inch and about 3 inches.

17. The scalable precision distribution aeroponic system of claim 15, wherein the one or more channels can define one or more atomized nutrient rich water solution congregation points.

18. The scalable precision distribution aeroponic system of claim 17, wherein the interchangeable growth media includes one or more plant apertures co-positioned at the one or more atomized nutrient rich water solution congregation points.

19. The scalable precision distribution aeroponic system of claim 15, further comprising a distribution nozzle positioned within the one or more channels, the distribution nozzle configured to introduce an atomized nutrient rich water solution into the one or more channels for distribution throughout at least a portion of the interchangeable growth media.

20. The scalable precision distribution aeroponic system of claim 15, further comprising at least one of a blower or vacuum mechanism configured to promote a flow of gas through the one or more channels, wherein the flow of gas is configured to at least one of promote an increase in distribution of the atomized nutrient rich water solution, aid in heat dissipation, enable temperature and/or humidity control of the root zone environment, or a combination thereof.
